(19) United States
(12) Patent Application Publication
(10) Pub. No.: US 2026/0186846 A1
(43) Pub. Date: Jul. 2, 2026

(54) APPARATUS AND METHOD FOR PHASE AWARE RECONFIGURABLE PROCESSOR DESIGN FOR OPTIMIZED PREFILL AND DECODE CLUSTER PERFORMANCE

(71) Applicant: Intel Corproation, Santa Clara, CA (US)

(72) Inventors: Mark C. Davis, Portland, OR (US); Karthik Tyamgondlu, Chandler, AZ (US); Vidhya Thyagarajan, Pleasanton, CA (US)

(73) Assignee: Intel Corporation, Santa Clara, CA (US)

(21) Appl. No.: 19/547,455

(22) Filed: Feb. 23, 2026

(51) Int. Cl. G06F 9/50; G06F 11/22

(52) U.S. Cl. CPC G06F 9/5038; G06F 9/5094; G06F 11/2236

(57) ABSTRACT

Apparatus and method for a reconfigurable processor for prefill and decode operations. An example processor comprises: compute circuitry to perform compute operations associated with prefill phase of an LLM workload in which first tokens of an input prompt are processed in parallel and a decode phase in which response tokens are generated sequentially; a memory controller; an input/output (I/O) controller; an interconnect fabric; and a management controller to select between a first plurality of operational modes responsive to detecting the prefill phase and a second plurality of operational modes responsive to detecting the decode phase, wherein the first plurality of operational modes are selected to enhance performance of the compute circuitry and the second plurality of operational modes are selected to enhance performance of the memory controller and the interconnect fabric.

### BACKGROUND

### Field of the Invention

This invention relates generally to the field of computing systems. More particularly, the invention relates to a phase aware reconfigurable processor design for optimized prefill and decode cluster performance.

### Description of the Related Art

Large Language Model (LLM) inference systems struggle to balance compute utilization with memory utilization and throughput with latency due to resource contention between the prefill and decode phases. Co-located serving forces a single model instance to optimize conflicting metrics, resulting in inefficient hardware utilization, unpredictable latency, and limited scalability. Disaggregated inference offers a solution but remains difficult to deploy at scale due to coordination complexity, static resource allocation, and lack of hardware support for dynamic rate matching.

### BRIEF DESCRIPTION OF THE DRAWINGS

A better understanding of the present invention can be obtained from the following detailed description in conjunction with the following drawings, in which:

FIG. 1 illustrates a processor architecture in accordance with some embodiments of this disclosure.

FIG. 2 illustrates embodiments of a distributed monitoring and control for a processor operable in multiple modes.

FIG. 3 illustrates a method in accordance with some embodiments of this disclosure.

FIG. 4A illustrates example subsystem temperature readings during a decode phase of a large language mode (LLM) workload.

FIG. 4B illustrates example subsystem temperature readings during a prefill phase of an LLM workload.

FIG. 5 illustrates an example implementation of a processor package comprising multiple dies.

### DETAILED DESCRIPTION

In accordance with embodiments of this disclosure, a processor (e.g., a System-on-Chip (SoC)) is configurable for disaggregated large language model (LLM) inference. In some implementations, a hardware-based construct with optimization capabilities configures the processor in various ways, including, but not limited to, static and explicit mode-bit configuration with processor binning, dynamic pattern-based optimization without reliance on mode bits, and hybrid implementations which combine explicit mode bits with dynamic optimization techniques for prefill and decode workloads. In some embodiments, an integrated hardware construct is initially configured and subsequently adjusted based on coordinated, prefill-aware and decode phase-aware reconfiguration—including explicit and implicit modes of operation (e.g., pattern detected modes).

These embodiments improve inference performance per watt by dynamically tailoring inferencing resources (e.g., compute and memory resources in particular) to each phase of an inferencing workload using a uniform silicon design, reducing both hardware costs and power consumption. Unlike prior implementations which require separate hardware or complex software orchestration, embodiments of this disclosure enable seamless transitions between prefill modes (e.g., with compute-focused processing) and decode modes (e.g., with memory-focused processing), while supporting cost-optimized binning strategies and real-time workload adaptation.

As an overview, LLM inference operations include a “prefill” phase and a “decode” phase which consume different processing resources. The prefill phase is the initial stage of the inference process where the model reads and processes an input prompt. The LLM model evaluates all tokens in the input prompt (a combination of words and parts of words) and calculates their internal representations in parallel (e.g., in a Key-Value (KV) cache). Because the prefill phase processes all input tokens simultaneously, this phase is highly parallelizable and is typically compute-bound, meaning its performance depends heavily on how fast the processor (e.g., a neural processing accelerator, graphics processor, etc.) can process the KV cache values, with the goal of understanding the context of the prompt so it can start to predict the response.

In the decode phase, the model generates the response, one token at a time, starting with the first token of the output. It then feeds the first token back into itself to generate the second token, followed by the third token, and so on, in an auto-regressive process in which each new token is based on all prior tokens. Because the processor generates tokens sequentially, the decode phase is harder to parallelize and is typically memory-bound, meaning its performance depends on how quickly data can be moved to and from memory.

As described further below, some embodiments of this disclosure include a System-on-Chip (SoC) architecture for disaggregated LLM inference that uses a single hardware construct with optimization capabilities defined statically and/or dynamically. For example, the SoC may be configured, statically or dynamically, to operate in multiple modes, including: (i) static mode configuration for specific hardware designs (e.g., static mode-bit configuration) with binning strategies; (ii) dynamic pattern-based optimization (e.g., without mode bits); and (iii) hybrid implementations combining static mode features with dynamic optimization for prefill and decode workloads.

Explicit mode bit configurations with processor binning can be used to solve the throughput-latency tradeoff in LLM inference with a single hardware design that is uniquely tailored for specific types of workload phases. For example, rather than dynamically modifying the configuration of processor subsystems in real-time, explicit configurations may be pre-selected and integrated on-chip during manufacture in view of the intended use of the processor. Processor binning may be performed in accordance with each manufactured processor's capabilities as determined by post-manufacture testing. For example, while each processor is manufactured with the same architecture, certain processors in a batch or across batches may exhibit differing performance capabilities due to inconsistencies in the manufacturing process. Processor bins may be defined based on the performance capabilities of each processor and the individual functional circuits within each processor-revealed during post-manufacture testing.

In accordance with these embodiments, a given processor or neural processing engine of an SoC may be configured with certain prefill optimization capabilities, decode capabilities, or a combination thereof. Power and frequency/voltage optimizations may be configured to dynamically adjust clock frequencies and voltages based on bottlenecks in each phase of a detected workload. For example, memory access frequencies and voltages may be increased for the decode phase and compute engine frequencies and voltages may be increased for the prefill phase.

These implementations operate in concert with the power management subsystem of the processor. For example, when the memory access frequencies are increased during the decode phase, the power management circuitry may reduce frequencies in other domains of the processor (e.g., the compute engines) to ensure that power consumption remains within a defined power envelope.

In these embodiments, the processor may be fused (or otherwise hardwired) to implement the desired processor characteristics, reducing costs and optimizing the processor for specific types of workloads. For example, a prefill-optimized processor SKU (stock keeping unit) may be configured with reduced High Bandwidth Memory (HBM) because the prefill phase relies less on memory capacity than the decode phase. In these embodiments, the firmware and software stacks can be customized to support the explicitly-defined hardware configurations. Additionally, the power management algorithms may be adapted to align with the specific static configuration of the hardware.

Note that the term “domain” is used herein to refer to a separately configurable portion of the processor, such as a processor subsystem with dedicated control registers and clock generation circuitry. For example, the processing engines, interconnect fabric, I/O subsystem, and memory subsystem may each be independently configured by writing to corresponding control registers and may be configured to operate at different power and performance levels via dedicated phase-locked loops (PLLs) (potentially in combination with separate voltage-controlled oscillators (VCOs)). In some instances, the terms domain and subsystem are used interchangeably herein.

In contrast to the explicit mode bit configurations described above, adaptive domain implementations perform dynamic resource management based on detected processor conditions and workload phases. In some embodiments, the management controller is configured to perform dynamic pattern-based detection to detect workload patterns in real-time and dynamically perform optimizations, including (but not limited to) adaptive domain power or frequency changes, memory subsystem optimizations, compute pipeline optimizations, fabric and interconnect optimizations (e.g., allocating and deallocating interconnect lanes), and input/output interconnect optimizations.

For example, a management controller may be configured to monitor telemetry data collected from various processor subsystems and access patterns across these subsystems (e.g., memory and cache subsystem, the interconnect fabric subsystem, the compute subsystem, and the I/O subsystem) and perform dynamic optimizations accordingly. The term “management controller” is used herein to refer to control circuitry which dynamically executes configuration changes to processor subsystems or domains, including power management decisions shift power budgets accordingly, based on the maximum defined power budget of the processor. For example, power sloshing may dynamically adjust the power consumed within each of these domains based on whether prefill or decode workload is currently being processed. The power adjustments may be implemented in various ways, such as by dynamically setting per-domain power budgets and corresponding per-domain frequency and voltage limits. Similarly, the management controller may dynamically configure specific performance levels for the processor subsystems (e.g., the compute subsystem, specific compute clusters, and/or the memory subsystem) based on an evaluation of the telemetry data and the current phase of the inferencing workload.

The memory subsystem optimizations may be based on detected memory access patterns (e.g., low-power double data rate (LP-DDR) or HBM access patterns), cache access patterns (e.g., different adaptive cache configurations for prefill phases and decode phases), or any combination thereof. For example, once a particular workload phase is detected (e.g., prefill or decode), specific memory subsystem optimizations may be requested and applied, based on memory subsystem characteristics and expected memory subsystem utilization of the workload phase.

The compute pipeline subsystem optimizations, in accordance with some embodiments, may also include dynamic precision mapping, in which the compute pipelines are dynamically configured to operate on inputs and output at specific precisions (e.g., FP16, INT8, FP8, INT4, etc) depending on the requirements of the respective workload phase. Power gating or low power states may also be implemented so that unused compute pipelines are selectively shut down to conserve (e.g., power-gated or placed in a specific low-power state).

Fabric and interconnect optimizations may include shared bus management configurations (e.g., intelligent traffic combination and routing decisions) and dynamic bus reconfigurations (e.g., bandwidth allocation based on detected requirements). For example, the processor can manage traffic routing and allocate bandwidth intelligently between different fabric/interconnects levels, such as between the system memory and the L2 or L3 cache, between the L2 cache and the L1 cache, and between the L1 cache and the compute engines. The management controller may also configure the number of active lanes on the fabric based on the current workload requirements (e.g., reducing the number of active lanes in response to low memory traffic and increasing the number of active lanes in response to heavy memory traffic). Additionally, the bandwidth (e.g., frequency and voltage) of the fabric/interconnect between compute engines within a compute cluster may similarly be intelligently managed.

The I/O optimizations can include lane management configurations and block disabling. For example, the I/O interface lanes may be adaptively enabled or disabled based on anticipated or currently detected access patterns via the I/O interconnect(s). As one non-limiting example, I/O interconnects may couple the processor to lower performance (“slow”) memory devices, such as CXL memory or external persistent memory. If a given set of lanes are not required for a given workload or phase, then they may be selectively disabled to conserve power which can be used by other subsystems. Additionally, non-critical blocks, such as media engines or encryption engines, can be selectively powered off (or set to low power) to conserve power for the active inference workload.

Thus, adaptive domain allocations as described herein may be used to intelligently manage processor resources based on the requirements of a current or anticipated workload or workload phase. While these embodiments offer dynamic flexibility, there may be instances in which the overhead associated with the dynamic reconfigurations reduce performance. For example, because operations such as detecting the current workload pattern and making corresponding configuration adjustments (e.g., updating control registers, resetting the phase locked loops (PLLs) providing the clock signals), the performance upside for certain workloads may be slightly lower than using explicit mode hints as described with respect to other approaches.

Some embodiments implement a hybrid approach, leveraging the benefits of both the explicit mode bit configuration and the real-time intelligence offered by adaptive domain management. As mentioned, the primary weakness of a fully adaptive approach is the latency overhead associated with detecting current conditions and determining an appropriate response.

In some hybrid embodiments, the explicit mode configuration is leveraged to generate an immediate mode-based hint to the management controller, which can then react nearly instantly to shift power budgets between domains (including maximum frequency and voltage thresholds), without waiting for the detection and telemetry analysis to determine an appropriate response. For example, based on the expected workload mode indicated by the hint, the management controller can promptly adjust power allocations across the various domains/subsystems (e.g., memory, cache, interconnect fabric, compute, and I/O).

After initially leveraging the mode-based hint, dynamic pattern-based optimizations may be implemented as previously described. In some cases, the dynamic optimizations may simply confirm the mode-based hint configurations. In other cases, the dynamic optimizations may include initial adjustments to the hint-based configurations, followed by a continual evaluation of the telemetry data and corresponding domain adjustments (e.g., in response to phase changes within a given workload or across multiple workloads).

Thus, a benefit of the hybrid embodiments is that the initial domain adjustments can be performed without delay (i.e., as soon as the mode-based hint is received). The management controller can then continually evaluate telemetry and workload data provided from each domain to determine appropriate domain configurations.

Table A provides a non-exhaustive list of domains and corresponding optimization techniques performed by the management controller.

Table A

| Domain/Subsystem | Optimization Techniques |
|---|---|
| Memory | Reduce memory bandwidth, frequency, and/or |
| Controller | voltage for prefill phase |
| | Memory stack selective disable |
| | Adaptive page policies (close/open/intelligent) |
| | Dynamic read-write latency thresholds |
| | Workload-aware low-power mode thresholds |
| | (including power gating) |
| Cache/Fabric | Selective power down of cache or portions thereof |
| | Dynamic cache way reduction |
| | Enable/disable of cache functions, such as data |
| | forwarding and snoop forwarding |
| | Frequency and voltage scaling based on access |
| | patterns |
| Compute Engine | Modify supported data types |
| | Selectively enable and disable threads |
| | Adjust Core count for optimization (e.g., core |
| | parking) |
| | Dynamic frequency, voltage, and power |
| | management |
| | Precision-based pipeline mapping |
| I/O | Media engine selective enable/disable |
| | Scale-up/scale-out lane management |
| | Low-latency path optimization |

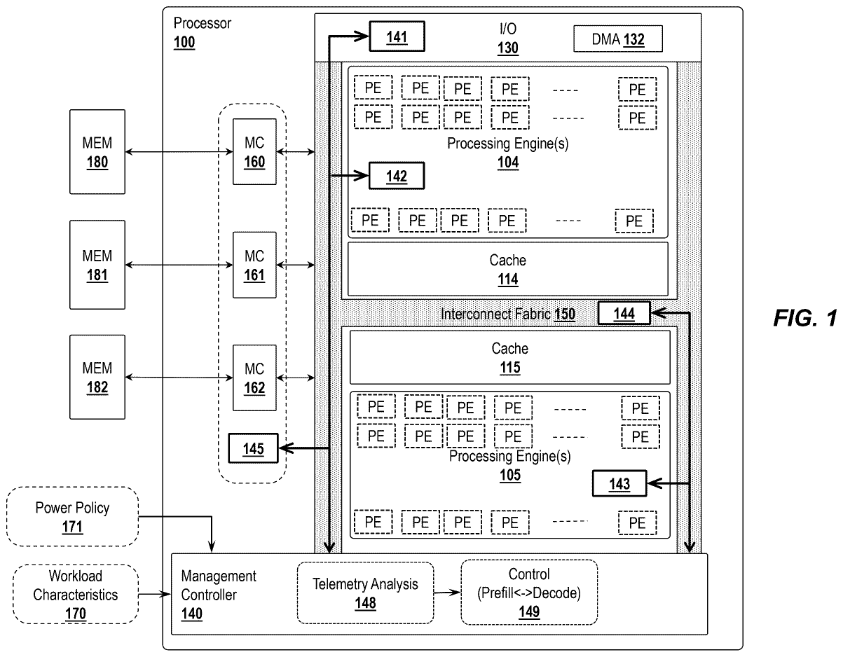

FIG. 1 illustrates an example processor 100 with a management controller 140 operable to evaluate telemetry data associated with different processor domains and mode-based hints to determine per-domain optimizations. The management controller 140 can operate in an explicit mode, an adaptive domain management mode, or a hybrid mode when performing inferencing operations. When operating in an adaptive or hybrid mode, telemetry analysis logic 148 of the management controller evaluates the telemetry data provided from various subsystems and, based on the analysis, control circuitry 149 communicates control signals to appropriately configure the operation of each respective subsystem.

The example processor 100 includes a plurality of processing engines 104-105 coupled to an interconnect fabric 150 and a memory subsystem comprising a plurality of cache memories 114-115 and memory controllers 160-162 providing access to one or more external memory devices 180-182 (including on-package memory and off-package memory). By way of example, and not limitation, the external memory devices 180-182 may include different combinations of volatile and/or non-volatile memory, such as High Bandwidth Memory (HBM), Double Data Rate memory (DDR), graphics double data rate memory (GDDR), and non-volatile RAM (NVRAM), to name a few. Each processing engine 104-105 may include a plurality of processing elements (PEs), such as compute cores, arithmetic logic units (ALUs), tensor cores, and general purpose computing cores (e.g., CPU cores).

The cache memories 114-115 may comprise hierarchically arranged SRAM memories. In some implementations, for example, the caches 114-115 include a plurality of Level-1 (L1) caches corresponding to individual processing elements, a plurality of Level-2 (L2) caches, typically shared by multiple processing elements (e.g., in clusters) and Level-3 (L3) or Last Level Caches (LLCs), typically shared by all or selected groups of the processing engines 104-105. Note, however, that the underlying principles of this disclosure are not limited to any particular types of memory devices or caches.

The processing engines 104-105 may comprise various heterogeneous processing elements (PEs) including, for example, one or more graphics processing cores, neural processing engines, tensor processing accelerators, general purpose processing cores (e.g., CPUs), and digital signal processor (DSP) cores. In some embodiments, scheduling logic (described further below), intelligently schedules workload phases or individual workloads to an appropriate set of processing elements (e.g., those processing elements capable of executing the workloads/phases efficiently while still meeting the requirements of the workload (e.g., required precisions, data types, latency thresholds, etc.).

Alternatively, the processing elements may be homogeneous, and configured to efficiently execute a specific set of workload phases or workload types. For example, in some embodiments, the processing elements comprise a plurality of compute cores (e.g., AI/tensor accelerator cores for accelerating matrix operations) configured, statically or dynamically, to execute prefill phases and decode phases of AI workloads as described herein.

One or more input/output interfaces 130 integrated on the processor 100 are coupled to the memory controllers 160-162 and caches 114-115 via the interconnect fabric 150. In some implementations, the I/O interfaces 130 include direct memory access (DMA) logic 132 to allow direct access to the memory controllers 160-162 and caches 114-115, thereby offloading memory operations from the processing engines 104-105 and, in some cases, allowing I/O devices to directly inject data into the caches 114-115 and memory devices 180-182.

In some implementations, the various processor components shown in FIG. 1 are arranged in power, frequency, and/or voltage domains, where each domain includes an independently configurable clock signal and voltage rail. For example, each processing engine 104-105 and/or each individual processing element (PE) may correspond to a separate domain. Similarly, the interconnect fabric 150, the I/O circuitry 130, the memory controllers 160-162, and the management controller 140 may each comprise a separate domain. The various configuration parameters described herein such as power budgets, frequency and voltage limits, and operational modes may be managed at the level of a corresponding domain.

In some implementations, the management controller 140 comprises a microcontroller or other type of processor which executes management firmware to perform the operations described herein. Each domain may expose a set of control registers accessible to the management controller 140, as well as supervisory firmware and software to configure the respective domain. For example, a plurality of agents 141-145 may be associated with the corresponding plurality of the domains to collect and communicate the telemetry data associated with each respective domain (e.g., operational metrics maintained in a set of registers). Based on the collected telemetry data, current workload characteristics 170 (e.g., prefill vs decode hints), and the specified power policy 171, the management controller 140 may perform one or more of the optimizations described herein.

By way of example, and not limitation, the telemetry data analyzed by the telemetry analysis logic 148 includes information related to memory access patterns (e.g., real-time detection of sequential vs random access patterns characteristic of prefill vs decode), compute utilization data (e.g., to distinguish between compute-intensive and memory-bound phases), cache miss rates (e.g., usable to intelligently adjust adaptive cache configurations), and power consumption profiling data (e.g., to make decisions based on the subsystems consuming the most power). Based on its evaluation of the telemetry data, control signaling circuitry 149 pushes configuration writes to respective control registers to adjust the operation of the relevant subsystems (e.g., the memory controllers 180-182, the fabric 150, the caches 114-115, and processing engines 104-105). For example, the configuration writes may cause a corresponding domain to operate as indicated in Table A.

While any number of domains and corresponding agents may be integrated in the processor 100, in the illustrated example, a first agent 141 is associated with the I/O interfaces 130, second and third agents, 142 and 143, are associated with processing engines 104 and 105, respectively, a fabric agent 144 is associated with the interconnect fabric 150, and a memory subsystem agent 145 is associated with the memory subsystem (including memory controllers 160-162). In operation, each agent 141-145 collects metrics associated with its respective domain and reports these metrics to the management controller 140. The operational metrics reported by the agents 141-145 to the management controller 140 may be performed periodically and/or on demand, and may include information to provide for informed power/performance management decisions, such as domain temperature readings, power consumption levels, and operational frequencies and voltages.

The management controller 140 evaluates the collected metrics, potentially in combination with the workload characteristics 170 and current power policy 171 (described below), to determine appropriate operational modes for each of the domains (e.g., a particular operational mode for each domain). In response to the determination, control circuitry 149 transmits control messages via the fabric 150 to the respective agents 141-145, which include local control circuitry to implement the specified operations. For example, in response to detecting workload characteristics corresponding to prefill operations, the management controller 140 may increase power, frequency, and/or voltage associated with one or more of the processing engines 104-105 (e.g., shifting power away from the memory subsystem). Conversely, in response to workload characteristics corresponding to decode operations, the management controller 140 may increase power, frequency, and/or voltage associated with one or more of the memory controllers 160-163 and the fabric 150.

The workload characteristics 170 may be directly communicated to the management controller 140 (e.g., as an explicit mode hint and/or from previously collected metrics). Alternatively, or additionally, the management controller 140 may implement a machine learning model to monitor and dynamically detect memory access patterns of different workloads, such as sequential access patterns characteristic of prefill operations, and random access patterns characteristic of decode operations. The control circuitry 149 may then responsively (e.g., in response to the management controller 140) transmit control signals to the agents 141-145 of the domains in accordance with the detected memory access patterns.

In some embodiments, the processing engine agents 142-143 monitor the utilization of each corresponding processing element and report the corresponding metrics back to the management controller 140, which evaluates the utilization metrics to make control decisions. For example, a compute-intensive workload or phase may be detected in response to compute utilization reaching one or more defined thresholds. In response, the management controller 140 may attempt to offload some of the work to alternate processing elements, or may increase the maximum frequency and voltage levels of the processing elements (e.g., while reducing the power consumption of other processor subsystems).

The management controller 140 may also evaluate metrics related to utilization of the caches 114-115, including the cache miss rate within different cache levels. In response, the control circuitry 149 may adaptively adjust the configuration of one or more caches to improve the miss rates (e.g., prefetching certain data into specific cache levels to reduce cache misses).

The management controller 140 may also make power and performance adjustments in accordance with defined priority or class of service (CLOS) levels associated with each workload. For example, a critical workload operating at the highest priority or CLOS level may be allocated a larger portion of the caches 114-115 and memory bandwidth. The cache allocation may be performed at the granularity of cache ways, with a larger number of cache ways being allocated to higher priority workloads. Similarly, relatively higher priority workloads may be allocated more lanes over the fabric 150 and/or the I/O interface 130 compared to lower priority or CLOS workloads. Workload priorities and CLOS levels may be specified via a set of control registers integral to the management controller 140.

In some implementations, the management controller 140 performs the management functions described herein based, at least in part, on a specified power policy 171. For example, the management controller 140 may perform dynamic optimizations to maintain power consumption within thresholds defined by the specified power policy 171, which may be weighted towards efficiency (e.g., when the power budget is limited or based on thermal conditions) or towards performance (e.g., when operating within the power and thermal budgets). Cost optimization may also be evaluated when rendering power management decisions (e.g., choosing the lowest cost option which still meets application requirements).

With respect to FIG. 1 and the other embodiments described herein, the interconnect fabric 150 may comprise various chip-level, package-level, and system-level interconnect links, depending on the processor architecture. The processing engines 104-105, caches 114-115, I/O circuitry 130 and memory controllers 160-162 may be integrated a single die (e.g., a single chip SoC), or may be arranged on separate interconnected dies in a multi-chip package or in separate components of a computer system. In some implementations, the memory devices 180-182 are integrated on the same package as the processor 100. Note, however, that the underlying principles of this disclosure are not limited to any particular multi-die or single die arrangement.

As mentioned, in an implementation with explicit mode bit configurations and binning, the processor 100 may be prefill-optimized (e.g., for reduced memory capacity and enhanced compute binning) or decode-optimized (e.g., with an enhanced memory subsystem and relaxed compute requirements). In contrast, an adaptive domain management or hybrid processor implementation can provide broad workload applicability with dynamic optimization options.

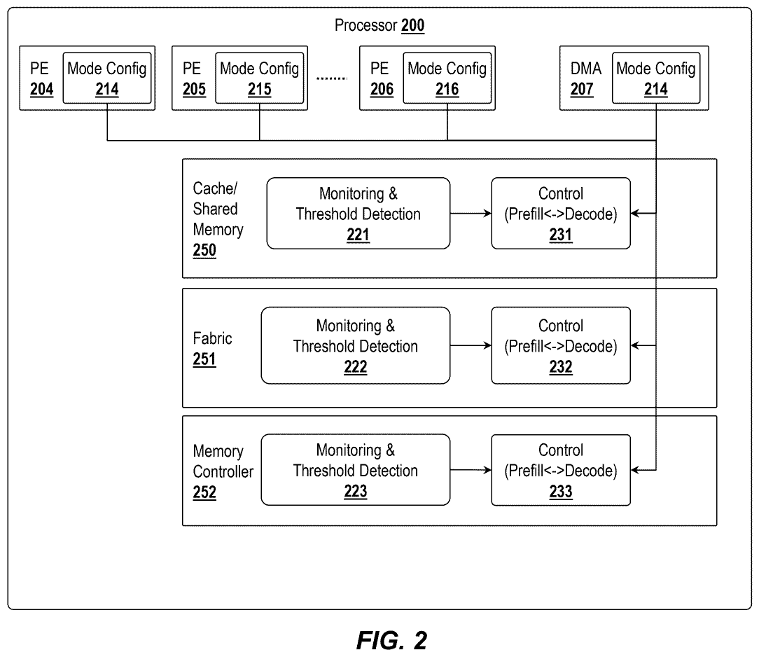

FIG. 2 illustrates another example representation of a processor 200 including a plurality of processing elements 204-206 configurable via respective mode configuration bits 213-216 (e.g., stored in corresponding mode configuration registers). A direct memory access (DMA) accelerator 207 integral to or coupled to the processor supports independent device memory access operations (e.g., without host processor intervention). In some embodiments, the DMA accelerator 207 is also configurable as described herein via a corresponding one or more mode configuration bits 214. As mentioned, the processing elements 204-206 may be any type of data processing circuitry including tensor processing circuitry, machine learning circuitry, graphics processing circuitry, and general purpose processing circuitry (e.g., CPU cores).

The processing elements 204-206 and DMA accelerator 207 are coupled via an interconnect fabric 251 to one or more levels of cache or shared local memory 250 and at least one memory controller 252 (on-chip or disaggregated) to couple the processor 200 to one or more system memory devices (e.g., HBM, DDR DRAM, etc.).

In the illustrated embodiment, the management controller comprises monitoring and threshold detection circuitry 221-223 distributed across domains 250-252 to collect operational metrics associated with the cache/shared memory 250, the interconnect fabric 251, and the memory controller 252. For example, each instance of monitoring and detection circuitry 221-223 may include a set of programmable counters and management registers to track metrics such as latency and bandwidth within its respective subsystem 250-252.

The monitoring and detection circuitry 221-223 may also detect specified events based on the collected operational metrics and responsively trigger notifications to respective control circuitry 231-233 of the corresponding subsystem 250-252. For example, if the latency associated with external memory access via the memory controller 252 exceeds a maximum threshold or of the requested bandwidth exceeds the current capacity, then the corresponding control circuitry 233, upon receiving the notification, can responsively adjust the operational mode of the memory controller 252. For example, in response to the memory bandwidth reaching a threshold, the control circuitry 233 may dynamically adjust the operational mode from a prefill mode to a decode mode (which is typically more memory-intensive).

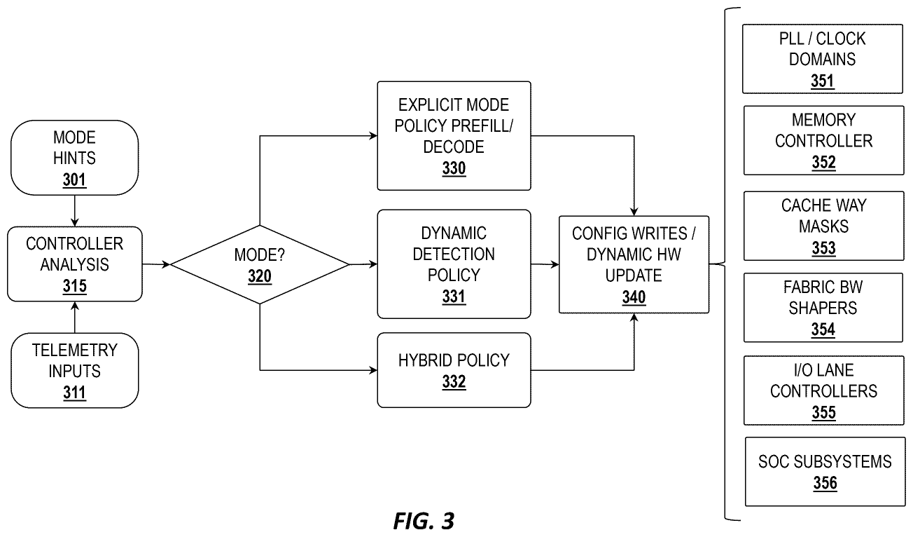

FIG. 3 illustrates a method implemented by management circuitry in accordance with some implementations (e.g., by management controller 140 or the monitoring & threshold detection circuitry 221-223 and corresponding control circuitry 231-233). The individual operations illustrated in FIG. 3 may be performed in hardware or with a combination of hardware and management firmware/software.

A controller analysis operation 315 is performed based on one or both of: telemetry inputs 311 received from various sources described herein (e.g., subsystem agents, sensors, etc.) and explicit mode hints 301 as previously described. As mentioned, relevant telemetry inputs can include the measure of sequential memory accesses relative to random memory accesses (e.g., with more sequential accesses indicating Prefill phases and more random accesses indicating Decode phases). Additionally, compute monitoring telemetry data may indicate if the workload is compute-intensive or memory-bound, cache miss rate telemetry data may be evaluated to identify cache access patterns, and power efficiency telemetry data may be used for power profiling operations.

As described, the controller analysis 315 may also make decisions based on mode based hints 301 which can include, for example, explicit mode bits set by the software within processing elements and processor subsystems. When operating in a hybrid mode (as described above), the controller analysis 315 can use these hints to quickly allocate resources for prefill or decode modes and subsequently perform a deeper analysis based on the telemetry inputs 311. Thus, the software hints 301 allow the controller analysis 315 (in some circumstances) to bypass the detection latency required for automatic recognition of the workload pattern—ensuring the power sloshing algorithm can leverage the hints without delay.

Based on the controller analysis 315, a particular operational mode is determined at 320, resulting in the selection of a corresponding policy bundle 330-332, which transmits configuration updates to all relevant processor subsystems at 340. For example, the controller analysis 315 may initially choose the explicit mode policy defined for prefill and decode workloads. After evaluating the telemetry inputs 311 (and for a period of time thereafter), the dynamic detection policy bundle 331 or the hybrid policy bundle 332 may be selected and the corresponding processor subsystems configured accordingly at 340.

Thus, after initially choosing the current operating phase based on mode hints 301, the management controller may subsequently choose the dynamic detection policy bundle 331 or the hybrid policy bundle 332 after ingesting and analyzing the telemetry inputs 311.

Table B provides an example set of configurable operational parameters in accordance with the embodiments described herein, and may be set in response to the management controller 140 detecting the prefill phase or the decode phase of an LLM workload. The parameters include memory frequency, which can be set to a high value (e.g., a maximum) for decode phases, which are memory-focused, and set to a low value (e.g., any frequency below the maximum) for prefill phases, which are compute-focused.

A page policy value is set to Open for prefill phases and Closed/Intelligent for decode phases. This is a memory controller setting which governs how memory pages are managed after an access. The system dynamically switches this policy to align with the specific memory access patterns of the current inference phase. For the Prefill phase, the policy is set to Open, which optimizes for sequential access patterns, which are characteristic of the prefill phase. Keeping the page open allows for faster continuous reading of data from the same memory row. For the Decode phase, the policy is set to “Closed” or “Intelligent,” which optimizes for random access patterns, which are characteristic of the decode phase. Closing the page (or using intelligent management) allows the management controller 140 to switch more quickly to different memory addresses for the next operation.

A read/write turnaround threshold value is a timing parameter within the memory controller that manages the delay required when switching the memory bus from reading mode to writing mode (and vice versa). This threshold is dynamically adjusted based on the workload phase to optimize efficiency. For the prefill phase the system sets this threshold to “Short,” because prefill involves massive, predictable data ingestion where switching overhead can be minimized or tightly scheduled. For the decode phase, the threshold is set to “Long,” due to the sporadic, random nature of the memory access during token generation, requiring more stable guard bands between direction switches to prevent data corruption or signal integrity issues.

Table B

| Parameter | Prefill Value | Decode Value |
|---|---|---|
| Memory Frequency | Low | High |
| Page Policy | Open | Close/Intelligent |
| R/W Turnaround | Short | Long |
| Threshold | | |
| Cache Ways Enabled | 8 | 4 |
| Pipeline Precision | INT8/FP16 | NVFP4 |
| Map | | |
| Interconnect Partition | 70% | 30% Compute, |
| | Compute, | 70% Mem |
| | 30% Mem | |
| I/O Lanes Enabled | All | Minimal |

The number of enabled cache ways is set to 8 for prefill and 4 for decode. This is done, at least in part, to optimize power efficiency by matching hardware resources to the specific needs of the workload. Dynamic way reduction is an optimization technique for the cache/fabric domains. By turning off half of the cache ways during the decode phase, the system can reduce power consumption in a phase where full cache associativity is not necessary. In addition, different numbers of cache ways may be enabled as an adaptation to detected workload patterns. For example, the management controller 140 may adjust the number of cache ways based on cache miss rates associated with the prefill and decode phases. The compute-intensive prefill phase benefits from higher associativity (8 ways), while the memory-bound decode phase can operate efficiently with fewer cache ways (4 ways).

The pipeline precision map values are set to INT8/FP16 for prefill and NVFP4 for decode to optimize the compute pipelines by matching the mathematical precision to the specific requirements of each workload phase. In particular, in the prefill phase, the compute pipelines are configured for INT8/FP16 (8-bit integer or 16-bit floating point) formats and in the decode phase, the compute pipelines are configured for NVFP4 (a lower-precision 4-bit floating point format). This allows the management controller 140 to dynamically allocate pipelines to higher precision versus lower precision operations based on the phase. Because the prefill phase is compute-intensive, it benefits from the standard precisions of INT8/FP16. In contrast, because the decode phase typically has relaxed compute requirements (being memory-bound), lower precision (e.g., NVFP4) can be used to optimize efficiency without sacrificing performance.

The interconnect partitioning values indicate the percentage of the interconnect fabric 150 allocated to the processing engines 104-105 and the memory controllers 160-162. Because the prefill phase is compute-intensive, a first partition comprising 70% of the interconnect fabric is allocated for compute (i.e., the PEs 104-105) and a second partition comprising 30% of the interconnect fabric is allocated to the memory controllers 160-162. These percentages are swapped for the decode phase, which requires significantly higher bandwidth to memory (i.e., a first partition comprising 30% of the interconnect fabric is allocated to compute and a second partition comprising 70% of the interconnect fabric is allocated to the memory controllers 160-162.

Additionally, for prefill phases, all I/O lanes of the I/O circuitry 130 are enabled (e.g., full ×8 scale-up connectivity) because the prefill phase can benefit from maximum bandwidth to handle the high volume of parallel data ingestion and processing. The management controller 140 reduces the number of enabled lanes for decode because the decode phase is less dependent on high I/O bandwidth. Thus, the management controller 140 performs adaptive lane enabling/disabling to adjust bandwidth as needed to conserve resources. In some embodiments, the management controller 140 performs I/O access pattern detection to dynamically enable or disable lanes.

Table C provides an example set of values associated with the relative bandwidth provided across bus links of the interconnect fabric 150 which (i) link the HBM 150-152 to the processor's L2 cache, (ii) link the L2 cache to the L1 caches of the processing elements, (iii) link the L1 caches to the processing elements (compute), and (iv) link different processing elements (compute <-> compute).

Table C

| Bus Utilization | Prefill | Decode |
|---|---|---|
| HBM ↔ L2 | 0.1x | 1x |
| L2 ↔ L1 | 1x | 0.2x |
| L1 ↔ Compute | 1x | 0.2x |
| Compute ↔ | 1x | 0.2x |
| Compute | | |

The different bus utilization values are a direct reflection of the contrasting bottlenecks and data movement patterns inherent to the prefill and decode phases. The management controller 140 can detect these utilization patterns (e.g., via telemetry counters) and perform dynamic switching when thresholds have been exceeded (e.g., switching between prefill and decode configurations). As indicated by the values in Table C, during a compute-bound prefill phase, the management controller 140 maximizes utilization of internal compute and cache buses while relying less on main memory bandwidth over the HBM↔L2 link. In particular, the HBM↔L2 bus is configured at only 0.1× utilization, while the L2↔L1, L1↔Compute, and Compute↔Compute buses all operate at 1× (maximum) utilization. This is because the prefill phase processes all input tokens in parallel, requiring heavy data movement between the compute units and the closest caches.

In the decode phase, the bottleneck flips and the processor requires maximum bandwidth to main memory, while the L2↔L1, L1↔Compute, and Compute↔Compute buses drop to 0.2× utilization. This reflects the memory-bound nature of the decode phase, where the system must constantly fetch model weights from HBM to generate each new token.

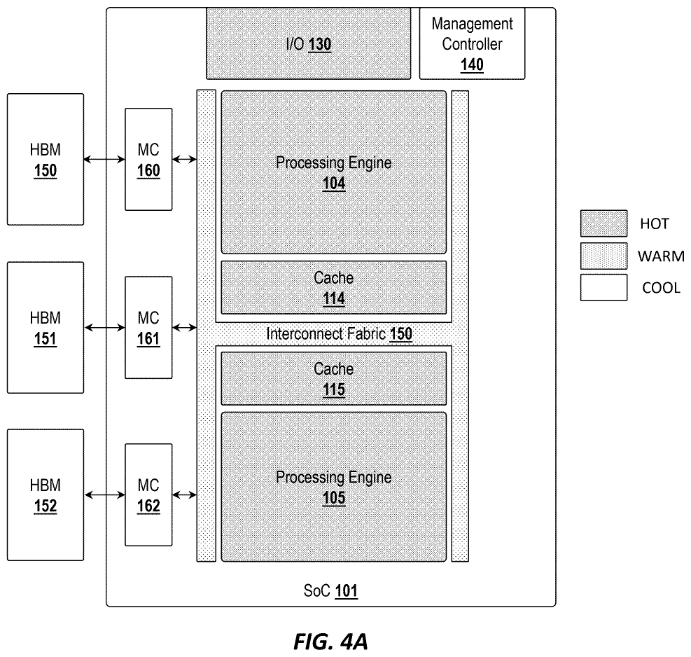

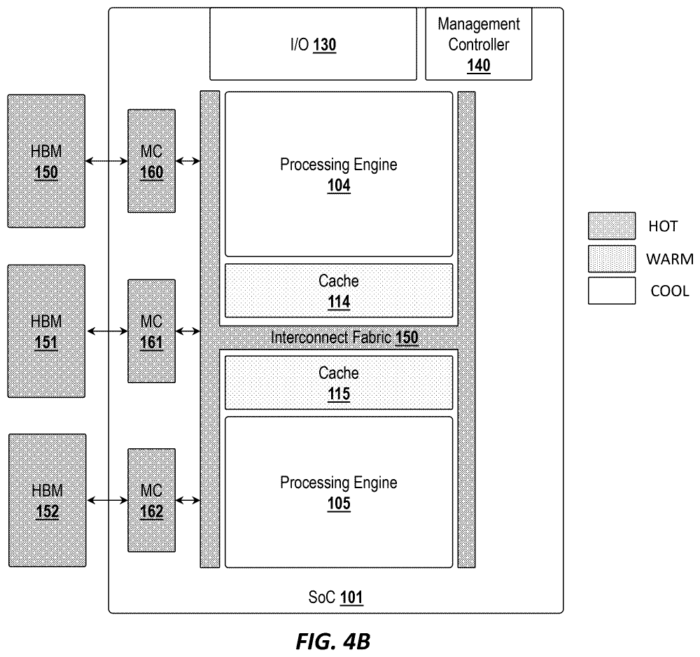

FIGS. 4A and 4B provide a graphical comparison of the temperatures of the processing engines 104-105, caches 114-115, interconnect fabric 150, memory controllers 160, and I/O circuitry 130 during the execution of a prefill workload phase (FIG. 4A) and a decode workload phase (FIG. 4B). Different fill patterns (indicated to the right) are used to indicate hot and warm temperatures and no fill is used to represent cool temperatures.

In FIG. 4A, the compute-bound prefill phase maximizes the utilization of the processing engines 104-105 and caches 114-115, causing high temperatures in these regions of the processor. Additionally, all I/O lanes of the I/O circuitry 130 are enabled for prefill phases to handle the high volume of parallel data ingestion and processing, thereby causing high temperatures in the I/O circuitry 130.

In contrast, in FIG. 4B, the memory-bound decode phase maximizes bandwidth to HBM 150-152 via memory controllers 160-162 and the interconnect fabric 150, thereby resulting in high temperature measurements in these regions of the processor. Because compute operations are reduced in the decode phase, the temperatures associated with the processing engines 104-105 remain low. The caches 114-115, positioned between the processing engines 104-105 and interconnect fabric 150, resulting in warm temperatures.

Tables D and E compare a baseline processor with a binned, prefill optimized processor and a binned, decode optimized processor, respectively. Note that the HMB capacity and bandwidth are significantly reduced in the prefill optimized processor, but is more than sufficient to support the compute-bound prefill phase of a workload. This results in reduced power consumption by the memory subsystem which can be reallocated to improve the compute performance (e.g., increasing the frequencies of the processing elements), resulting in a 30% performance improvement.

The number of cores is reduced from 96 to 32 in the decode optimized processor, given that the decode phase of a workload is memory-bound. The power conserved with significantly fewer cores can be reallocated to the memory subsystem and interconnect fabric, as indicated, resulting in a 20% performance improvement over the baseline.

Table D

| | | Prefill | |
|---|---|---|---|
| | Baseline | Optimized | |
| Metrics | SOC | SOC | Notes |
| TDP (Watts) | ISO | ISO | |
| Processor Cores | 96 | 96 | |
| Max HBM | 288 | 96 | Reduce HBM Cap |
| Capacity (GB) | | | |
| HBM BW | 15 | 5 | Reduce HBM BW |
| FP8 PFLOPS | 5.4 | 7 | Allocate Mem TDP to |
| (Perf@TDP) | | | Compute Perf |
| Scale-Up | UAL 1.6 TB/s | UAL 1.6 TB/s | UAlink |
| (Bi-directional) | | | |
| Scale-up | x8 | x8 | |
| connectivity | | | |
| (UAL) | | | |
| Perf | 1x | 1.3x | 30% Perf Upside |
| (inferences/sec) | | | |

Table E

| | Baseline | Decode Optimized | |
|---|---|---|---|
| Metrics | SOC | SOC | Notes |
| TDP (Watts) | ISO | ISO | |
| Processor Cores | 96 | 32 | Reduce Compute |
| Max HBM | 288 | 288 | |
| Capacity (GB) | | | |
| HBM BW (JS) | 15 | 18 | Allocate power to |
| | | | Mem SS and Fabric |
| FP8 PFLOPS | 5.4 | 1.8 | Reduce Compute |
| (Perf@TDP) | | | |
| Scale-Up | UAL | UAL | |
| (Bi-directional) | 1.6 TB/s | 1.6 TB/s | |
| Scale-up | x8 | x4 | Reduce bandwidth |
| connectivity | | | |
| (UAL) | | | |
| Perf | 1x | 1.2x | 20% Perf Upside |
| (inferences/sec) | | | |

Thus, processor binning may be performed in accordance with Table F, which indicates the capabilities, features, and performance for a prefill-optimized SKU, a decode-optimized SKU, and a unified/dynamic SKU. In addition to optimizing both the numerator and denominator for total cost of ownership (TCO) (e.g., perf/$), additional cost/yield benefits result from this type of binning strategy. It also allows more drastic EU and HBM recovery options to enable a zero-fallout SKU strategy.

Table F

| | | | Features | | |
|---|---|---|---|---|---|
| | HBM | Compute | Fused/ | Firmware | Policy |
| SKU Type | Capacity | Fmax | Disabled | Detection | Selection |
| Prefill- | Reduced | High | Extra HBM | SKU ID: | Prefill |
| Optimized | | | channels off | 0x01 | Policy |
| Decode- | Full | Relaxed | 50% cores | SKU ID: | Decode |
| Optimized | | | fused out | 0x02 | Policy |
| Unified/ | Full | High | All enabled | SKU ID: | Hybrid |
| Dynamic | | | | 0x03 | Policy |

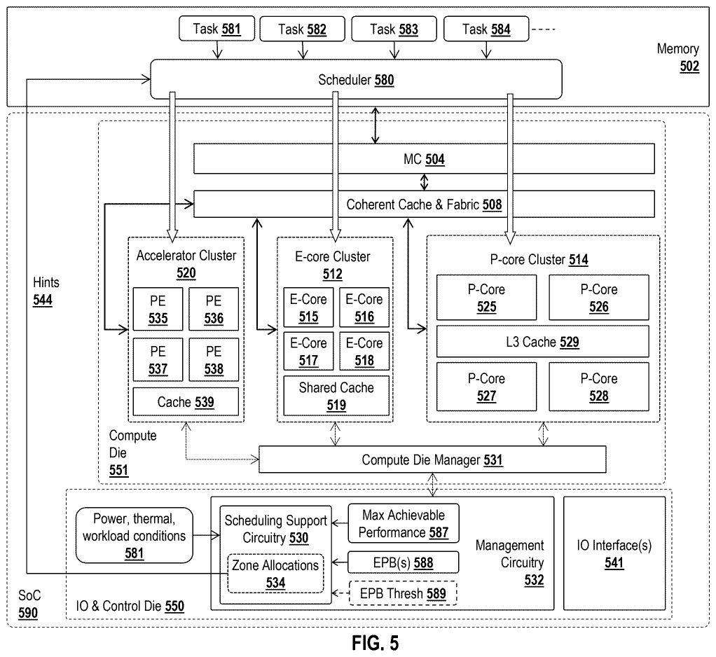

FIG. 5 illustrates an example implementation of an SoC 590 comprising a plurality of domains distributed across multiple dies, including a compute die 551 with an efficiency core cluster 512 comprising a plurality of efficiency cores 515-518 and a shared cache 519, a performance core cluster 514 comprising a plurality of performance cores 525-528 and a shared cache 529, and an accelerator cluster 520 comprising a plurality of processing elements (PEs). An I/O & control die 550 includes input/output (IO) interface circuitry 541 and management circuitry 532 with scheduling support circuitry 530 for generating scheduling hints 544 based on current power, thermal, and workload conditions 581 and current zone allocations 534 as described herein. The efficiency core cluster 512 and performance core cluster 514 are coupled to a memory 502 (e.g., a DRAM system memory) via a coherent fabric & cache 508 (e.g., a last-level cache (LLC)) and memory controller 504.

In the illustrated example, the management circuitry 532 evaluates telemetry data provided from the various SoC domains (e.g., the memory controller 504, accelerator cluster 520, E-core cluster 512, P-core cluster 514 and I/O interface 541), potentially in combination with explicit mode hints as described herein and power, thermal, and workload characteristics 581 and responsively transmits configuration writes to respective control registers to adjust the operation of the relevant domains.

The compute die 551 may be coupled to the IO & control die 550 via die-to-die interconnects, such as those provided by an Embedded Multi-die Interconnect Bridge (EMIB). While a multi-die implementation is shown in FIG. 5, the underlying principles of the invention may be implemented on a single-die processor or on a multi-die processor with more than two dies.

In some implementations, the management circuitry 532 on the IO & control die 550 is a supervisor power manager (e.g., such as supervisor P-unit 1630 described above). The management circuitry 532 makes SoC-wide management decisions based, at least in part, on information provided by a compute die power manager 531, which performs local management for the compute die 551.

As mentioned, the scheduling support circuitry 530 communicates with a scheduler 580 which schedules a plurality of tasks 581-584 on the efficiency core cluster 512 and/or the performance core cluster 514 in accordance with the techniques described herein. In some embodiments, the scheduler 580 is provided in an operating system or other supervisory software or firmware. Based on current conditions related to power, temperature, and/or characteristics of workloads 581, the scheduling support hardware 530 provides hints 544 (e.g., scheduling recommendations) to the scheduler 580 related to task placement on the performance cluster 512 and the efficiency cluster 514. While the scheduling support circuitry 530 is shown as integral to the management circuitry 532, the scheduling support circuitry 530 and management circuitry 532 may be separate but interconnected circuit blocks on the IO & control die 550.

In some implementations, the management circuitry 532 determines a maximum achievable performance requirement 587 based on the specified EPB value(s) 588, which may be stored in a control register such as an MSR. When the efficiency cluster 512 is capable of meeting the maximum achievable performance requirement 587 based on the energy/performance bias value(s) 588, the management circuitry 532 assigns the efficiency core cluster 512 to the performance zone instead of the performance core cluster 514. The scheduling support circuitry 530 or the management circuitry 532 generate the corresponding zone allocations 534 which map the efficiency core cluster 512 and performance core cluster 514 to different zones based on current energy/performance bias value(s) 588 and the corresponding maximum achievable performance requirement 587 (e.g., as indicated in one or more MSRs).

By way of example, and not limitation, the zones may include a performance zone for performance-oriented tasks, an efficiency zone for efficiency-oriented tasks, and a multithreading zone for multithreaded tasks. The scheduling support circuitry 530 or management circuitry 532 may map either the efficiency cluster 512 or the performance cluster 514 to the performance zone based on the current efficiency/performance bias value(s) 588 and/or the maximum achievable performance 587. In one particular implementation, the efficiency cluster 512 is mapped to the efficiency zone and the performance cluster 514 is mapped to the multithreading zone regardless of the efficiency/performance bias value(s) 588. In other embodiments, however, the mapping of clusters to zones is dynamic, allowing any cluster to be mapped to any defined zone.

In some implementations, the EPB value 588 is based on a normalized sliding scale (e.g., between 0-15), where relatively larger values indicate a bias towards energy and relatively lower values indicate a bias towards performance. In some embodiments, an EPB threshold 589 is indicated in a control register, such as another MSR. An EPB value 588 greater than or equal to the threshold value is considered biased towards energy and an EPB value less than the threshold is considered biased towards performance. The mapping between clusters and zones is then performed accordingly (e.g., as indicated in Table 6).

An accelerator cluster 520 comprising a set of accelerator cores 535-538 and cache 539 is integrated in the compute die 551. The accelerator cores 535-538 may be graphics cores, neural processing unit (NPU) cores (e.g., for performing machine-learning operations such as matrix multiplications), tensor processing cores, data compression cores, or any other core types used for acceleration operations.

In these implementations, the accelerator cluster 520 may be mapped to a particular zone based, at least in part, on the EPB value(s) 588 and/or the maximum achievable performance 587. For example, with an EPB value indicating a preference for performance, the accelerator cluster 520 may be mapped to the performance zone and/or the multithreading zone. In some embodiments, another zone is defined, such as a second performance zone or an acceleration zone, which is enabled and mapped to the acceleration cluster 520 for certain types of workloads. As previously described, the scheduling support circuitry 530 may then communicate the zone allocations 534 as hints 544 to the scheduler 580 which responsively schedules tasks 581-584 in accordance with the zone allocations 534.

### EXAMPLES

The following are example implementations of different embodiments of the invention.

Example 1. A processor, comprising: compute circuitry to perform compute operations associated with phases of a large language model (LLM) workload, including a prefill phase in which the compute circuitry process first tokens of an input prompt in parallel and a decode phase in which the compute circuitry sequentially generates response tokens; a memory controller to be coupled to a system memory; an input/output (I/O) controller to be coupled to one or more I/O devices; an interconnect fabric to couple the compute circuitry and I/O controller to the memory controller to access the system memory; and a management controller to select a first plurality of operational modes for the compute circuitry, the memory controller, the I/O controller, and the interconnect fabric responsive to detecting the prefill phase and to select a second plurality of operational modes for the compute circuitry, the memory controller, the I/O controller, and the interconnect fabric responsive to detecting the decode phase, wherein the first plurality of operational modes are selected to enhance performance of the compute circuitry and the second plurality of operational modes are selected to enhance performance of the memory controller and the interconnect fabric.

Example 2. The processor of example 1, wherein the management controller is to select between the first and second plurality of operational modes responsive to at least one of: an explicit mode indication configured in the processor and telemetry data collected from each of the compute circuitry, the memory controller, the I/O controller, and the interconnect fabric.

Example 3. The processor of examples 1 or 2, further comprising: a plurality of management agents, including a first management agent associated with the compute circuitry, a second management agent associated with the memory controller, a third management agent associated with the I/O controller, and a fourth management agent associated with the interconnect fabric, wherein each management agent is to provide a respective portion of the telemetry data to the management controller.

Example 4. The processor of any of examples 1-3, wherein the management controller is to transmit first control messages to cause the first, second, third, and fourth management agents to implement the first plurality of operational modes in the compute circuitry, the memory controller, the I/O controller, and the interconnect fabric, respectively, and is to transmit second control messages to cause the first, second, third, and fourth management agents to implement the second plurality of operational modes in the compute circuitry, the memory controller, the I/O controller, and the interconnect fabric, respectively.

Example 5. The processor of any of examples 1-4, wherein the first plurality of operational modes comprises a first plurality of corresponding power levels, frequency levels, or voltage levels and the second plurality of operational modes comprises a second plurality of corresponding power levels, frequency levels, or voltage levels.

Example 6. The processor of any of examples 1-5, wherein the explicit mode indication is fused in the processor during a binning process including testing capabilities of the processor.

Example 7. The processor of any of examples 1-6, wherein when the explicit mode indication comprises a prefill-optimized indication, the management controller is to select the first plurality of operational modes to enhance performance of the compute circuitry and when the explicit mode indication comprises a decode-optimized indication, the management controller is to select the second plurality of operational modes to enhance performance of the memory controller and the interconnect fabric.

Example 8. The processor of any of examples 1-7, wherein the first plurality of operational modes includes enablement of a larger number of cache ways than used in the second plurality of operational modes, higher precision data formats than used in the second plurality of operational modes, a larger number of enabled I/O lanes of the I/O controller than used in the second plurality of operational modes, and a lower memory frequency than used in the second plurality of operational modes.

Example 9. The processor of any of examples 1-8, wherein the first plurality of operational modes are to allocate a larger portion of the interconnect fabric to the compute circuitry than in the second plurality of operational modes.

Example 10. A machine-readable medium having program code stored thereon which, when executed by one or more processors, is to cause the one or more processors to perform operations, comprising: performing, by compute circuitry, compute operations associated with phases of a large language model (LLM) workload, including a prefill phase in which the compute circuitry process first tokens of an input prompt in parallel and a decode phase in which the compute circuitry sequentially generates response tokens, wherein the compute circuitry is coupled to a memory controller and an input/output (I/O) controller via an interconnect fabric; and selecting, by a management controller, a first plurality of operational modes for the compute circuitry, the memory controller, the I/O controller, and the interconnect fabric responsive to detecting the prefill phase and to select a second plurality of operational modes for the compute circuitry, the memory controller, the I/O controller, and the interconnect fabric responsive to detecting the decode phase, wherein the first plurality of operational modes are selected to enhance performance of the compute circuitry and the second plurality of operational modes are selected to enhance performance of the memory controller and the interconnect fabric.

Example 11. The machine-readable medium of example 10, selecting between the first and second plurality of operational modes is to be performed responsive to at least one of: an explicit mode indication and telemetry data collected from each of the compute circuitry, the memory controller, the I/O controller, and the interconnect fabric.

Example 12. The machine-readable medium of examples 10 or 11, further comprising program code to cause the one or more processors to perform the operations of: providing, by each of a plurality of management agents, a respective portion of the telemetry data to the management controller, the plurality of management agents including a first management agent associated with the compute circuitry, a second management agent associated with the memory controller, a third management agent associated with the I/O controller, and a fourth management agent associated with the interconnect fabric.

Example 13. The machine-readable medium of any of examples 10-12, further comprising program code to cause the one or more processors to perform the operations of: transmitting, by the management controller, first control messages to cause the first, second, third, and fourth management agents to implement the first plurality of operational modes in the compute circuitry, the memory controller, the I/O controller, and the interconnect fabric, respectively, and transmitting, by the management controller, second control messages to cause the first, second, third, and fourth management agents to implement the second plurality of operational modes in the compute circuitry, the memory controller, the I/O controller, and the interconnect fabric, respectively.

Example 14. The machine-readable medium of any of examples 10-13, wherein the first plurality of operational modes comprises a first plurality of corresponding power levels, frequency levels, or voltage levels and the second plurality of operational modes comprises a second plurality of corresponding power levels, frequency levels, or voltage levels.

Example 15. The machine-readable medium of any of examples 10-14, wherein the explicit mode indication is fused in a processor containing the compute circuitry or the management controller during a binning process including testing capabilities of the processor.

Example 16. The machine-readable medium of any of examples 10-15, wherein when the explicit mode indication comprises a prefill-optimized indication, the management controller is to select the first plurality of operational modes to enhance performance of the compute circuitry and when the explicit mode indication comprises a decode-optimized indication, the management controller is to select the second plurality of operational modes to enhance performance of the memory controller and the interconnect fabric.

Example 17. The machine-readable medium of any of examples 10-15, wherein the first plurality of operational modes includes one or more of: enablement of a larger number of cache ways than used in the second plurality of operational modes, higher precision data formats than used in the second plurality of operational modes, a larger number of enabled I/O lanes of the I/O controller than used in the second plurality of operational modes, and a lower memory frequency than used in the second plurality of operational modes.

Example 18. The machine-readable medium of any of examples 10-17, wherein the first plurality of operational modes are to allocate a larger portion of the interconnect fabric to the compute circuitry than in the second plurality of operational modes.

Example 19. A method, comprising: performing, by compute circuitry, compute operations associated with phases of a large language model (LLM) workload, including a prefill phase in which the compute circuitry process first tokens of an input prompt in parallel and a decode phase in which the compute circuitry sequentially generates response tokens, wherein the compute circuitry is coupled to a memory controller and an input/output (I/O) controller via an interconnect fabric; and selecting, by a management controller, a first plurality of operational modes for the compute circuitry, the memory controller, the I/O controller, and the interconnect fabric responsive to detecting the prefill phase and to select a second plurality of operational modes for the compute circuitry, the memory controller, the I/O controller, and the interconnect fabric responsive to detecting the decode phase, wherein the first plurality of operational modes are selected to enhance performance of the compute circuitry and the second plurality of operational modes are selected to enhance performance of the memory controller and the interconnect fabric.

Example 20. The method of example 19, selecting between the first and second plurality of operational modes is to be performed responsive to at least one of: an explicit mode indication and telemetry data collected from each of the compute circuitry, the memory controller, the I/O controller, and the interconnect fabric.

Example 21. The method of examples 19 or 20, further comprising: providing, by each of a plurality of management agents, a respective portion of the telemetry data to the management controller, the plurality of management agents including a first management agent associated with the compute circuitry, a second management agent associated with the memory controller, a third management agent associated with the I/O controller, and a fourth management agent associated with the interconnect fabric.

Example 22. The method of any of examples 19-21, further comprising: transmitting, by the management controller, first control messages to cause the first, second, third, and fourth management agents to implement the first plurality of operational modes in the compute circuitry, the memory controller, the I/O controller, and the interconnect fabric, respectively, and transmitting, by the management controller, second control messages to cause the first, second, third, and fourth management agents to implement the second plurality of operational modes in the compute circuitry, the memory controller, the I/O controller, and the interconnect fabric, respectively.

Example 23. The method of any of examples 19-22, wherein the first plurality of operational modes comprises a first plurality of corresponding power levels, frequency levels, or voltage levels and the second plurality of operational modes comprises a second plurality of corresponding power levels, frequency levels, or voltage levels.

Example 24. The method of any of examples 19-23, wherein the explicit mode indication is fused in a processor containing the compute circuitry or the management controller during a binning process including testing capabilities of the processor.

Example 25. The method of any of examples 19-24, wherein when the explicit mode indication comprises a prefill-optimized indication, the management controller is to select the first plurality of operational modes to enhance performance of the compute circuitry and when the explicit mode indication comprises a decode-optimized indication, the management controller is to select the second plurality of operational modes to enhance performance of the memory controller and the interconnect fabric.

Example 26. The method of any of examples 19-25, wherein the first plurality of operational modes includes one or more of: enablement of a larger number of cache ways than used in the second plurality of operational modes, higher precision data formats than used in the second plurality of operational modes, a larger number of enabled I/O lanes of the I/O controller than used in the second plurality of operational modes, and a lower memory frequency than used in the second plurality of operational modes.

Example 27. The method of any of examples 19-26, wherein the first plurality of operational modes are to allocate a larger portion of the interconnect fabric to the compute circuitry than in the second plurality of operational modes.

Embodiments of this disclosure may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals-such as carrier waves, infrared signals, digital signals, etc.).

In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment may be implemented using different combinations of software, firmware, and/or hardware.

Throughout this detailed description, for the purposes of explanation, numerous specific details were set forth in order to provide a thorough understanding of the present disclosure. It will be apparent, however, to one skilled in the art that these embodiments may be practiced without some of these specific details. In certain instances, well known structures and functions were not described in elaborate detail in order to avoid obscuring the subject matter of the present disclosure. Accordingly, the scope and spirit of the invention should be judged in terms of the claims which follow.

What is claimed is:

1. A processor, comprising:
compute circuitry to perform compute operations associated with phases of a large language model (LLM) workload, including a prefill phase in which the compute circuitry process first tokens of an input prompt in parallel and a decode phase in which the compute circuitry sequentially generates response tokens;
a memory controller to be coupled to a system memory;
an input/output (I/O) controller to be coupled to one or more I/O devices;
an interconnect fabric to couple the compute circuitry and I/O controller to the memory controller to access the system memory; and
a management controller to select a first plurality of operational modes for the compute circuitry, the memory controller, the I/O controller, and the interconnect fabric responsive to detecting the prefill phase and to select a second plurality of operational modes for the compute circuitry, the memory controller, the I/O controller, and the interconnect fabric responsive to detecting the decode phase,
wherein the first plurality of operational modes are selected to enhance performance of the compute circuitry and the second plurality of operational modes are selected to enhance performance of the memory controller and the interconnect fabric.

2. The processor of claim 1, wherein the management controller is to select between the first and second plurality of operational modes responsive to at least one of: an explicit mode indication configured in the processor and telemetry data collected from each of the compute circuitry, the memory controller, the I/O controller, and the interconnect fabric.

3. The processor of claim 2, further comprising:
a plurality of management agents, including a first management agent associated with the compute circuitry, a second management agent associated with the memory controller, a third management agent associated with the I/O controller, and a fourth management agent associated with the interconnect fabric, wherein each management agent is to provide a respective portion of the telemetry data to the management controller.

4. The processor of claim 3, wherein the management controller is to transmit first control messages to cause the first, second, third, and fourth management agents to implement the first plurality of operational modes in the compute circuitry, the memory controller, the I/O controller, and the interconnect fabric, respectively, and is to transmit second control messages to cause the first, second, third, and fourth management agents to implement the second plurality of operational modes in the compute circuitry, the memory controller, the I/O controller, and the interconnect fabric, respectively.

5. The processor of claim 1, wherein the first plurality of operational modes comprises a first plurality of corresponding power levels, frequency levels, or voltage levels and the second plurality of operational modes comprises a second plurality of corresponding power levels, frequency levels, or voltage levels.

6. The processor of claim 2, wherein the explicit mode indication is fused in the processor during a binning process including testing capabilities of the processor.

7. The processor of claim 6, wherein when the explicit mode indication comprises a prefill-optimized indication, the management controller is to select the first plurality of operational modes to enhance performance of the compute circuitry and when the explicit mode indication comprises a decode-optimized indication, the management controller is to select the second plurality of operational modes to enhance performance of the memory controller and the interconnect fabric.

8. The processor of claim 6, wherein the first plurality of operational modes includes enablement of a larger number of cache ways than used in the second plurality of operational modes, higher precision data formats than used in the second plurality of operational modes, a larger number of enabled I/O lanes of the I/O controller than used in the second plurality of operational modes, and a lower memory frequency than used in the second plurality of operational modes.

9. The processor of claim 8, wherein the first plurality of operational modes are to allocate a larger portion of the interconnect fabric to the compute circuitry than in the second plurality of operational modes.

10. A machine-readable medium having program code stored thereon which, when executed by one or more processors, is to cause the one or more processors to perform operations, comprising:
performing, by compute circuitry, compute operations associated with phases of a large language model (LLM) workload, including a prefill phase in which the compute circuitry process first tokens of an input prompt in parallel and a decode phase in which the compute circuitry sequentially generates response tokens, wherein the compute circuitry is coupled to a memory controller and an input/output (I/O) controller via an interconnect fabric; and
selecting, by a management controller, a first plurality of operational modes for the compute circuitry, the memory controller, the I/O controller, and the interconnect fabric responsive to detecting the prefill phase and to select a second plurality of operational modes for the compute circuitry, the memory controller, the I/O controller, and the interconnect fabric responsive to detecting the decode phase,
wherein the first plurality of operational modes are selected to enhance performance of the compute circuitry and the second plurality of operational modes are selected to enhance performance of the memory controller and the interconnect fabric.

11. The machine-readable medium of claim 10, selecting between the first and second plurality of operational modes is to be performed responsive to at least one of: an explicit mode indication and telemetry data collected from each of the compute circuitry, the memory controller, the I/O controller, and the interconnect fabric.

12. The machine-readable medium of claim 11, further comprising program code to cause the one or more processors to perform the operations of:
providing, by each of a plurality of management agents, a respective portion of the telemetry data to the management controller, the plurality of management agents including a first management agent associated with the compute circuitry, a second management agent associated with the memory controller, a third management agent associated with the I/O controller, and a fourth management agent associated with the interconnect fabric.

13. The machine-readable medium of claim 12, further comprising program code to cause the one or more processors to perform the operations of:
transmitting, by the management controller, first control messages to cause the first, second, third, and fourth management agents to implement the first plurality of operational modes in the compute circuitry, the memory controller, the I/O controller, and the interconnect fabric, respectively, and
transmitting, by the management controller, second control messages to cause the first, second, third, and fourth management agents to implement the second plurality of operational modes in the compute circuitry, the memory controller, the I/O controller, and the interconnect fabric, respectively.

14. The machine-readable medium of claim 10, wherein the first plurality of operational modes comprises a first plurality of corresponding power levels, frequency levels, or voltage levels and the second plurality of operational modes comprises a second plurality of corresponding power levels, frequency levels, or voltage levels.

15. The machine-readable medium of claim 11, wherein the explicit mode indication is fused in a processor containing the compute circuitry or the management controller during a binning process including testing capabilities of the processor.

16. The machine-readable medium of claim 15, wherein when the explicit mode indication comprises a prefill-optimized indication, the management controller is to select the first plurality of operational modes to enhance performance of the compute circuitry and when the explicit mode indication comprises a decode-optimized indication, the management controller is to select the second plurality of operational modes to enhance performance of the memory controller and the interconnect fabric.

17. The machine-readable medium of claim 15, wherein the first plurality of operational modes includes one or more of: enablement of a larger number of cache ways than used in the second plurality of operational modes, higher precision data formats than used in the second plurality of operational modes, a larger number of enabled I/O lanes of the I/O controller than used in the second plurality of operational modes, and a lower memory frequency than used in the second plurality of operational modes.

18. The machine-readable medium of claim 17, wherein the first plurality of operational modes are to allocate a larger portion of the interconnect fabric to the compute circuitry than in the second plurality of operational modes.

19. A method, comprising:
performing, by compute circuitry, compute operations associated with phases of a large language model (LLM) workload, including a prefill phase in which the compute circuitry process first tokens of an input prompt in parallel and a decode phase in which the compute circuitry sequentially generates response tokens, wherein the compute circuitry is coupled to a memory controller and an input/output (I/O) controller via an interconnect fabric; and
selecting, by a management controller, a first plurality of operational modes for the compute circuitry, the memory controller, the I/O controller, and the interconnect fabric responsive to detecting the prefill phase and to select a second plurality of operational modes for the compute circuitry, the memory controller, the I/O controller, and the interconnect fabric responsive to detecting the decode phase,
wherein the first plurality of operational modes are selected to enhance performance of the compute circuitry and the second plurality of operational modes are selected to enhance performance of the memory controller and the interconnect fabric.

20. The method of claim 19, selecting between the first and second plurality of operational modes is to be performed responsive to at least one of: an explicit mode indication and telemetry data collected from each of the compute circuitry, the memory controller, the I/O controller, and the interconnect fabric.
